(19) United States
(12) Patent Application Publication
(10) Pub. No.: US 2025/0392533 A1
(43) Pub. Date: Dec. 25, 2025

(54) REMOTE AUDIO MIXING

(71) Applicant: Nuven USA, Brea, CA (US)

(72) Inventor: James Cho, Brea, CA (US)

(73) Assignee: Nuven USA, Brea, CA (US)

(21) Appl. No.: 19/244,208

(22) Filed: Jun. 20, 2025

Related U.S. Application Data
(60) Provisional application No. 63/662,722, filed on Jun. 21, 2024.

(51) Int. Cl. H04L 43/10; G11B 27/031; H04L 9/00

(52) U.S. Cl. CPC H04L 43/10; G11B 27/031; H04L 9/008

(57) ABSTRACT

An electronic device that provides data packets is described. During operation, the electronic device may receive control data associated with an audio mixer at a first location, where the control data has a first data format. Then, the electronic device may convert the control data from the first data format to a second data format, where the control data having the second data format is included in data packets. Note that the first data format may include a User Datagram Protocol (UDP) and the second data format may include a Transmission Control Protocol (TCP). Moreover, the electronic device may add data tracking elements to the data packets. Next, the electronic device may provide, addressed to a second electronic device, the data packets, where the second electronic device is at a second location that is different from the first location.

### CROSS REFERENCE TO RELATED APPLICATIONS

This application claims priority under 35 U.S.C. 119 (e) to: U.S. Provisional Application Ser. No. 63/662,722, “System and Method for Remote Audio Mixing,” filed on Jun. 21, 2024, by James Cho, et al, the contents of which are herein incorporated by reference.

### FIELD

The described embodiments relate to techniques for audio mixing. In particular, the described embodiments relate to techniques for live audio mixing from a remote location.

### BACKGROUND

Audio engineers are typically needed onsite to perform live mixing and troubleshooting. However, the cost of hiring an audio engineer is often prohibitively expensive. This can limit access to these services. In addition, there are often significant time constraints. For example, consumers may need to wait for an audio engineer to travel to their locations, which can result in delays in receiving support. Similarly, audio engineers usually cannot take on as many jobs or employment opportunities because of these spatial and temporal constraints.

### SUMMARY

An electronic device that provides data packets is described. This electronic device includes an interface circuit that communicates with a second electronic device. During operation, the electronic device receives control data associated with an audio mixer at a first location, where the control data has a first data format. Then, the electronic device converts the control data from the first data format to a second data format, where the control data having the second data format is included in the data packets. Moreover, the electronic device adds data tracking elements to the data packets. Next, the electronic device provides, addressed to the second electronic device, the data packets, where the second electronic device is at a second location that is different from the first location.

Note that the first data format may include User Datagram Protocol (UDP) and the second data format may include Transmission Control Protocol (TCP). (However, in other embodiments, the second data format may include UDP.) In general, the electronic device may support communication with the second electronic device using UDP or TCP depending on a network configuration.

Moreover, the second location may be remotely located from the first location.

Furthermore, prior to providing the data packets, the electronic device may encrypt the data packets.

Additionally, the providing may be via a network and a server. For example, the network may include the Internet.

In some embodiments, the data tracking elements may facilitate tracking of packet delivery at the server and/or the second electronic device. Moreover, the data tracking elements may facilitate tracking of an order in which the data packets are received at the server and/or the second electronic device.

Note that the second electronic device is associated with an audio engineer.

Moreover, the audio mixer may be different from the electronic device.

Furthermore, the electronic device may perform the receiving, the converting, the adding, and the providing for different control data associated with different audio and/or video streams and, when provided, are addressed to different destinations.

Another embodiment provides the second electronic device that performs counterpart operations to the aforementioned operations. For example, the second electronic device may receive, associated with the audio mixer, second data packets that include audio and/or video. Then, the second electronic device tracks delivery and data-packet order of the data packets. Moreover, the second electronic device performs audio mixing based at least in part on the control data and the audio and/or the video.

For example, the audio mixing may be based at least in part on one or more inputs from the audio engineer at the second location.

In some embodiments, the second electronic device may perform troubleshooting based at least in part on the control data and the audio and/or the video.

Moreover, the electronic device and/or the second electronic device may include a real-time analyzer (RTA) module. The RTA module may allow the audio engineer to capture and analyze an acoustic response of a venue using an audio microphone coupled to the electronic device or the audio mixer. Based at least in part on the acoustic response, the audio engineer may use the second electronic device to remotely calibrate and adjust room equalization parameters, e.g., during a live session.

Furthermore, the electronic device and/or the second electronic device may support (e.g., using hardware and/or software) integration with a third-party intercom system. This may enable seamless communication between one or more remote engineers using one or more instances of the second electronic device and on-site personnel, e.g., via one or more instances of the electronic device.

Another embodiment provides the cloud-based server. This server may relay traffic associated with and coordinate operation for multiple simultaneous remote sessions between instances of the electronic device at different venues with instances of the second electronic device associated with different audio engineers. For example, the server may relay traffic and coordinate operation for a given instance of the electronic device and a given instance of the second electronic device.

Another embodiment provides a computer-readable storage medium with program instructions for use with one of the electronic device, the server or the second electronic device. When executed by the electronic device, the server or the second electronic device, the program instructions cause the electronic device, the server or the second electronic device to perform at least some of the aforementioned operations in one or more of the preceding embodiments.

Another embodiment provides a method, which may be performed by the electronic device, the server or the second electronic device. This method includes at least some of the aforementioned operations in one or more of the preceding embodiments.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices in accordance with an embodiment of the present disclosure.

FIG. 2 is a flow diagram illustrating an example of a method for providing data packets using an electronic device in FIG. 1 in accordance with an embodiment of the present disclosure.

FIG. 3 is a block diagram illustrating an example of communication among the electronic device, a server and a second electronic device in accordance with an embodiment of the present disclosure.

FIG. 4 is a drawing illustrating an example of a RMIX service signal flow in accordance with an embodiment of the present disclosure.

FIG. 5 is a drawing illustrating an example of functionality of components in a RMIX service system in accordance with an embodiment of the present disclosure.

FIG. 6 is a drawing illustrating an example of communication among components for a RMIX service in accordance with an embodiment of the present disclosure.

FIG. 7 is a drawing illustrating an example of communication among components for a RMIX service in accordance with an embodiment of the present disclosure.

FIG. 8 is a drawing illustrating an example of communication among components for a RMIX service in accordance with an embodiment of the present disclosure.

FIG. 9A is a drawing illustrating an example of communication among components for a RMIX service in accordance with an embodiment of the present disclosure.

FIG. 9B is a drawing illustrating an example of communication among components for a RMIX service in FIG. 9A in accordance with an embodiment of the present disclosure.

FIG. 10A is a drawing illustrating an example of communication among components for a RMIX service in accordance with an embodiment of the present disclosure.

FIG. 10B is a drawing illustrating an example of communication among components for a RMIX service in FIG. 10A in accordance with an embodiment of the present disclosure.

FIG. 11 is a drawing illustrating an example of a format of a data packet in accordance with an embodiment of the present disclosure.

FIG. 12 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

An electronic device that provides data packets is described. This electronic device may include an interface circuit that communicates with a second electronic device. During operation, the electronic device may receive control data associated with an audio mixer at a first location, where the control data has a first data format. Then, the electronic device may convert the control data from the first data format to a second data format, where the control data having the second data format is included in data packets. Note that the first data format may include UDP and the second data format may include TCP. (However, in other embodiments, the second data format may include UDP.) Moreover, the electronic device may add data tracking elements to the data packets. Next, the electronic device may provide, addressed to the second electronic device, the data packets, where the second electronic device is at a second location that is different from the first location.

By converting from the first data format to the second data format, and providing the data packets, these communication techniques may facilitate remote audio mixing and/or troubleshooting. Notably, the communication techniques may increase the reliability of the communication with the second electronic device, and may facilitate tracking of delivery at the second electronic device (including an order in which the data packets are received). This may reduce the cost, complexity and time needed to perform the audio mixing and/or the troubleshooting. Consequently, the communication techniques may improve the user experience when communicating the data packets and/or using the audio mixer.

In the discussion that follows, electronic devices or components in a system communicate packets in accordance with a wireless communication protocol, such as: a wireless communication protocol that is compatible with an IEEE 802.11 standard (which is sometimes referred to as ‘Wi-Fix,’ from the Wi-Fi Alliance of Austin, Texas), Bluetooth, a cellular-telephone network or data network communication protocol (such as a third generation or 3G communication protocol, a fourth generation or 4G communication protocol, e.g., Long Term Evolution or LTE (from the 3rd Generation Partnership Project of Sophia Antipolis, Valbonne, France), LTE Advanced or LTE-A, a fifth generation or 5G communication protocol, or other present or future developed advanced cellular communication protocol), UDP (from the Internet Engineering Task Force of Fremont, California), TCP (from the Internet Engineering Task Force of Fremont, California), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Moreover, an access point, a radio node, a base station or a switch in the wireless network may communicate with a local or remotely located computer (such as a controller) using a wired communication protocol, such as a wired communication protocol that is compatible with an IEEE 802.3 standard (which is sometimes referred to as ‘Ethernet’), e.g., an Ethernet II standard. However, a wide variety of communication protocols may be used in the system, including wired and/or wireless communication. In the discussion that follows, UDP and TCP are used as illustrative examples.

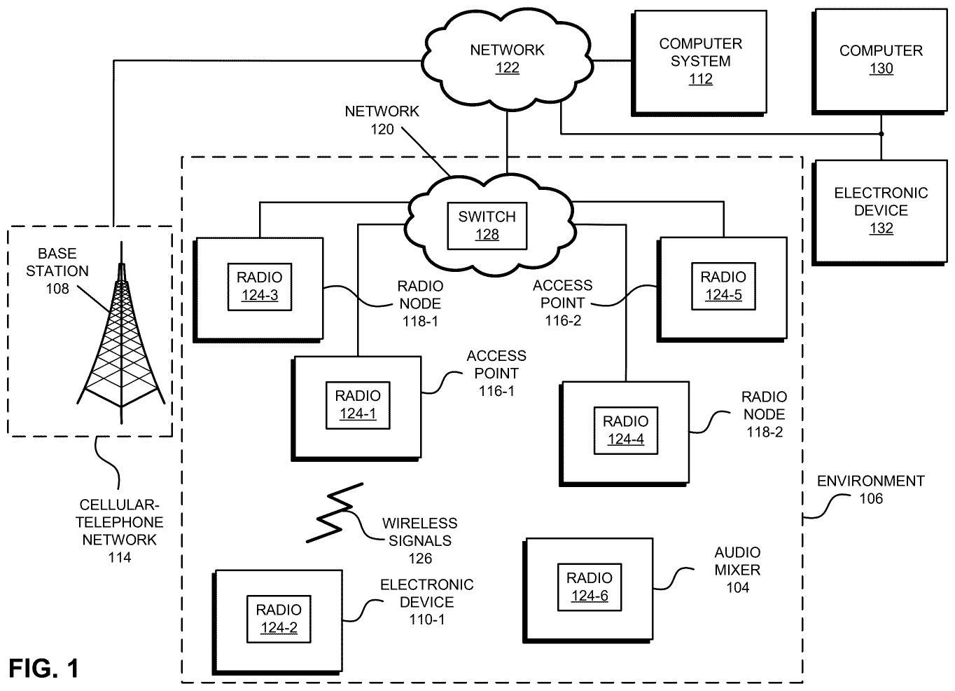

We now describe some embodiments of the communication techniques. FIG. 1 presents a block diagram illustrating an example of communication in an environment 106 with one or more electronic devices (such as electronic device 110-1, e.g., a cellular telephone, a portable electronic device, a station or client, another type of electronic device, etc., which are sometimes referred to as ‘end devices’) via a cellular-telephone network 114 (which may include a base station 108), one or more access points 116 (which may communicate using Wi-Fi) in a WLAN and/or one or more radio nodes 118 (which may communicate using LTE) in a small-scale network (such as a small cell). For example, the one or more radio nodes 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘communication device.’ Moreover, as noted previously, one or more base stations (such as base station 108), access points 116, and/or radio nodes 118 may be included in one or more wireless networks, such as: a WLAN, a small cell, and/or a cellular-telephone network. In some embodiments, access points 116 may include a physical access point and/or a virtual access point that is implemented in software in an environment of an electronic device or a computer.

Note that audio mixer 104, electronic device 110-1, access points 116 and/or radio nodes 118 may communicate with each other, audio mixer 104, computer system 112 (which may be a cloud-based controller that manages and/or configures access points 116, radio nodes 118 and/or switch 128, or that provides cloud-based storage and/or analytical services), computer 130, electronic device 132, and/or authentication computer (not shown, such as a RADIUS server and/or an AAA server) using a wired communication protocol (such as Ethernet) via network 120 and/or 122. Note that networks 120 and 122 may be the same or different networks. For example, networks 120 and/or 122 may be: an LAN, an intra-net or the Internet. In some embodiments, network 120 may include one or more routers and/or switches (such as switch 128). In FIG. 1, note that a controller may provide various management and control and functionalities.

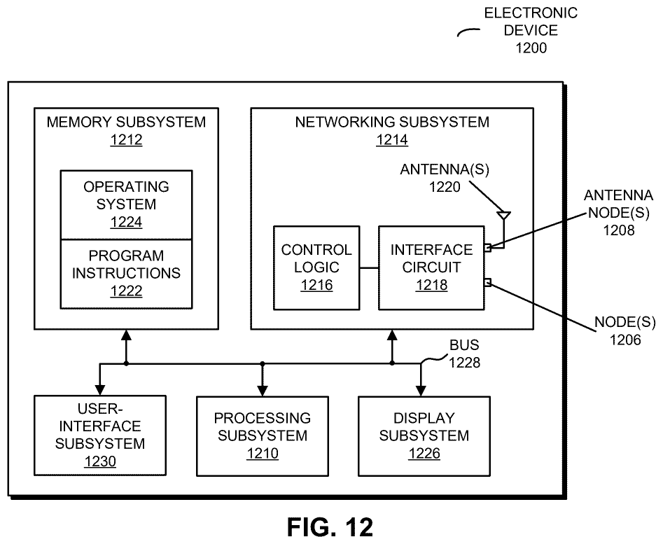

As described further below with reference to FIG. 12, audio mixer 104, electronic device 110-1, computer system 112, access points 116, radio nodes 118, switch 128, computer 130 and electronic device 132 may include subsystems, such as a networking subsystem, a memory subsystem and a processor subsystem. In addition, electronic device 110-1, access points 116 and radio nodes 118 may include radios 124 in the networking subsystems. More generally, electronic device 110-1, access points 116 and radio nodes 118 can include (or can be included within) any electronic devices with the networking subsystems that enable electronic device 110-1, access points 116 and radio nodes 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options, transmit and receive frames or packets via the connection, etc.

During the communication in FIG. 1, access points 116 and/or radio nodes 118 and electronic device 110-1 may wired or wirelessly communicate while: transmitting access requests and receiving access responses on wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio nodes 118 and electronic device 110-1. For example, radio 124-1 in access point 116-1 may transmit information (such as one or more packets or frames) using wireless signals 126. These wireless signals are received by radios 124 in one or more other electronic devices (such as radio 124-2 in electronic device 110-1). This may allow access point 116-1 to communicate information to other access points 116 and/or electronic device 110-1. Note that wireless signals 126 may convey one or more packets or frames.

In the described embodiments, processing a packet or a frame in access points 116 and/or radio nodes 118 and electronic device 110-1 may include: receiving the wireless signals with the packet or the frame; decoding/extracting the packet or the frame from the received wireless signals to acquire the packet or the frame; and processing the packet or the frame to determine information contained in the payload of the packet or the frame.

Note that the wireless communication in FIG. 1 may be characterized by a variety of performance metrics, such as: a data rate for successful communication (which is sometimes referred to as ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as: 900 MHZ, 2.4 GHZ, 5 GHZ, 6 GHZ, 7 GHZ, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multi-user transmission (such as orthogonal frequency division multiple access or OFDMA).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

As discussed previously, it can be expensive and time-consuming to have an audio engineer physically present at a given live music performance. In order to address this challenge, the communication techniques enable remote audio mixing and troubleshooting by one or more audio engineers.

Notably, electronic device 110-1 may receive control data associated with audio mixer 104 at a first location, where the control data has a first data format. Then, electronic device 110-1 may convert the control data from the first data format to a second data format, where the control data having the second data format is included in the data packets. For example, the first data format may include UDP and the second data format may include TCP. (However, in other embodiments, the second data format may include UDP.)

Moreover, electronic device 110-1 may add data tracking elements to the data packets. Next, electronic device 110-1 may optionally encrypt the data packets (e.g., using OpenSSL). Furthermore, electronic device 110-1 may provide, addressed to a second electronic device (such as electronic device 132, which may be associated with an audio engineer), the data packets, where electronic device 132 is at a second location that is different from the first location. For example, the second location may be remotely located from the first location. Note that the data packets may be provided to electronic device 132 via network 122 and computer 130 (such as a server).

The data tracking elements in the data packets may facilitate tracking of packet delivery at computer 130 and/or electronic device 132. Moreover, the data tracking elements may facilitate tracking of an order in which the data packets are received at computer 130 and/or electronic device 132. In some embodiments, computer 130 and/or electronic device 132 may use the data tracking elements to reorder the data packets, e.g., into sequential order.

After receiving the data packets, electronic device 132 may associate the data packets with second data packets that include audio and/or video, and that are received from audio mixer 104. Then, electronic device 132 may perform audio mixing based at least in part on the control data and the audio and/or the video. For example, the audio mixing may be based at least in part on one or more inputs from the audio engineer at the second location. In some embodiments, electronic device 132 may perform troubleshooting (e.g., of audio mixer 104) based at least in part on the control data and the audio and/or the video.

Note that electronic device 110-1 may provide data packets associated with different audio and/or video streams (e.g., associated with the same or different customers) to multiple electronic devices (such as different remotely located electronic devices, not shown) associated with different remotely located audio engineers. Note that the multiple electronic devices (which may have similar capabilities to electronic device 132) may be at different remote locations or destinations.

Moreover, electronic device 110-1 and/or electronic device 132 may include an RTA module. The RTA module may allow the audio engineer to capture and analyze an acoustic response of a venue using an audio microphone coupled to electronic device 110-1 or audio mixer 104. Based at least in part on the acoustic response, the audio engineer may use electronic device 132 to remotely calibrate and adjust room equalization parameters, e.g., during a live session.

Furthermore, electronic device 110-1 and/or electronic device 132 may support (e.g., using hardware and/or software) integration with one or more third-party intercom systems, such as Clear-Com (from Clear-Com of Carlsbad, California) and an RTS Intercom System (from Keenfinity GmbH of München, Germany). This may enable seamless communication between one or more remote engineers using one or more instances of electronic device 132 and on-site or on-venue personnel, e.g., via one or more instances of electronic device 110-1 (which may be at different venues or locations).

Additionally, computer 130 may relay traffic associated with and coordinate operation for multiple simultaneous remote sessions between instances of electronic device 110-1 at different venues with instances of electronic device 132 associated with different audio engineers. For example, computer 130 may relay traffic and coordinate operation for a given instance of electronic device 110-1 and a given instance of electronic device 132.

In these ways, the communication techniques may facilitate remote audio mixing and/or troubleshooting. Notably, the communication techniques may increase the reliability of the communication with electronic device 132, and may facilitate tracking of delivery at electronic device 132 (including an order in which the data packets are received). This may reduce the cost, complexity and time needed to perform the audio mixing and/or the troubleshooting. Consequently, the communication techniques may improve the user experience when communicating the data packets and/or using audio mixer 104.

While the preceding discussion illustrated electronic device 110-1 performing the operations in the communication techniques, in other embodiments at least some of the operations may be performed by or in conjunction with another component in FIG. 1. For example, at least some of the aforementioned operations may be performed by audio mixer 104. For example, in some embodiments, some or all of the functionality of electronic device 110-1 may be included in audio mixer 104.

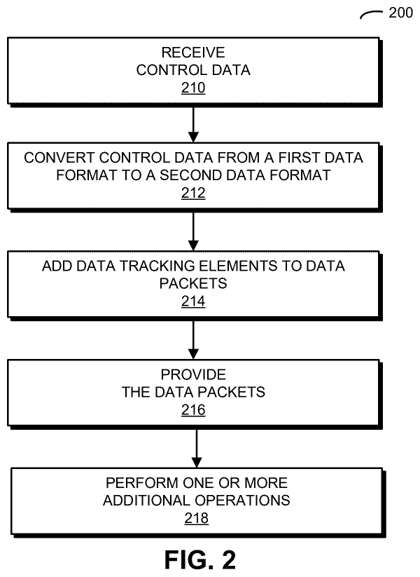

We now describe embodiments of the method. FIG. 2 presents a flow diagram illustrating an example of a method 200 for providing data packets, which may be performed by an electronic device, such as electronic device 110-1 in FIG. 1. During operation, the electronic device may receive control data (operation 210) associated with an audio mixer at a first location, where the control data has a first data format. Then, the electronic device may convert the control data from the first data format to a second data format (operation 212), where the control data having the second data format is included in the data packets. Moreover, the electronic device may add data tracking elements to the data packets (operation 214). Next, the electronic device may provide, addressed to a second electronic device, the data packets (operation 216), where the second electronic device is at a second location that is different from the first location.

Note that the first data format may include UDP and the second data format may include TCP.

Moreover, the second location may be remotely located from the first location.

Furthermore, the providing (operation 216) may be via a network and a server. For example, the network may include the Internet.

In some embodiments, the data tracking elements may facilitate tracking of packet delivery at the server and/or the second electronic device. Moreover, the data tracking elements may facilitate tracking of an order in which the data packets are received at the server and/or the second electronic device.

Note that the second electronic device may be associated with an audio engineer.

Moreover, the audio mixer may be different from the electronic device.

In some embodiments, the electronic device may optionally perform one or more optional additional operations (operation 218). For example, prior to providing the data packets (operation 216), the electronic device may encrypt the data packets.

Moreover, the electronic device may perform the receiving (operation 210), the converting (operation 212), the adding (operation 214), and the providing (operation 216) for different control data associated with different audio and/or video streams and, when provided, are addressed to different destinations.

In some embodiments of method 200, there may be additional or fewer operations. Furthermore, the order of the operations may be changed, and/or two or more operations may be combined into a single operation.

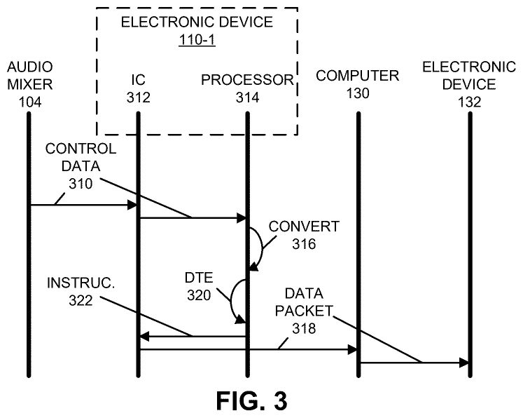

FIG. 3 presents a drawing illustrating an example of communication between audio mixer 104, electronic device 110-1, computer 130 and electronic device 132. Notably, audio mixer 104 (at a first location) may provide control data 310 to electronic device 110-1, where control data 310 has a first data format. After interface circuit (IC) 312 in electronic device 110-1 receives control data 310, control data 310 may be provided to processor 314 in electronic device 110-1. Processor 314 may convert 316 control data 310 from the first data format to a second data format, where control data 310 having the second data format is included in data packets 318. Moreover, processor 314 may add data tracking elements (DTE) 320 to data packets 318. Next, processor 314 may instruct 322 interface circuit 312 to provide, addressed to electronic device 132 (at a different location from the first location), data packets 318. Note that data packets 318 may be provided to electronic device 132 via computer 130 (such as a cloud-based server).

While FIG. 3 illustrates some operations using unilateral or bilateral communication (which are, respectively, represented by one-sided and two-sided arrows), in general a given operation in FIG. 3 may involve unilateral or bilateral communication. Moreover, while FIG. 3 illustrates operations being performed sequentially or at different times, in other embodiments at least some of these operations may, at least in part, be performed concurrently or in parallel.

We now further describe the communication techniques. In existing audio-production environments, particularly within small to mid-sized venues, access to experienced on-site sound engineers is often inconsistent or unavailable. Existing live audio mixing systems generally require engineers to be physically present, or may rely on venue-specific setups that are difficult to standardize and replicate across multiple locations.

Most digital audio mixing systems currently in use are designed to operate within local area networks (LANs), using manufacturer-specific communication protocols between control software and mixing hardware. These systems typically employ direct device-to-device connections or communicate through intermediate network infrastructure. While the existing systems support bidirectional synchronization between control interfaces and audio processors, they are usually fundamentally restricted by local network boundaries.

Some remote-control attempts have used port forwarding or static Internet Protocol (IP) configurations to extend mixer access beyond a local network. However, these approaches often introduce substantial security vulnerabilities by exposing internal systems to the public Internet, and are usually not viable across venues with different information-technology environments. Moreover, existing remote-mixer solutions typically are brand-specific and may offer little to no interoperability, which may limit scalability and cross-venue deployment.

The absence of a standardized, secure, and flexible remote-mixing infrastructure has left current solutions fragmented and technically burdensome. Consequently, these systems often require redundant hardware, complicated network configurations, or manual intervention to maintain off-site control.

These challenges are addressed using the disclosed communication techniques. Notably, a system and techniques for remotely controlling venue-based digital audio mixers via a secure, cloud-mediated relay architecture are described. This architecture may enable real-time (e.g., during a performance at a venue) audio mixing from one or more remote locations without relying on port forwarding, virtual private networks (VPNs), or device-specific software. In some embodiments, the system may include brand-agnostic translation modules, centralized-session management, and/or network address translation (NAT) traversal mechanisms. These capabilities may enable seamless, scalable operation across a wide range of audio-mixer hardware and/or network configurations.

The communication techniques may enable remote real-time or live audio mixing and/or troubleshooting (e.g., by accurately identifying issues and implementing appropriate solutions in real-time) by a remotely located audio engineer(s). The communication techniques may allow the audio engineer(s) to access or remotely control the on-site, digital mixing console (which is sometimes referred to as an ‘audio mixer’) of a venue (such as a music or concert hall, a company, a church, etc.) with ultra-low latency and high-quality audio and without modifying the Internet router setup on either side of the communication link between the digital mixing console and the electronic devices used by the remotely located audio engineer(s). Thus, the communication techniques may enable high-quality sound mixing (e.g., by adjusting one or more channels) regardless of the physical location(s) of the audio engineer(s).

These capabilities may allow consumers to be paired or matched with audio engineers based at least in part on specific needs, skill levels, availability, and/or pricing. This flexibility may give consumers and audio engineers more freedom in choosing the most suitable options for their requirements. Therefore, the communication techniques may provide a reliable, high-quality, and flexible solution for real-time or live-mixing and troubleshooting, benefiting both consumers and audio engineers. This may ensure that more people can access professional audio services, ultimately enhancing the overall audio experience in various venues.

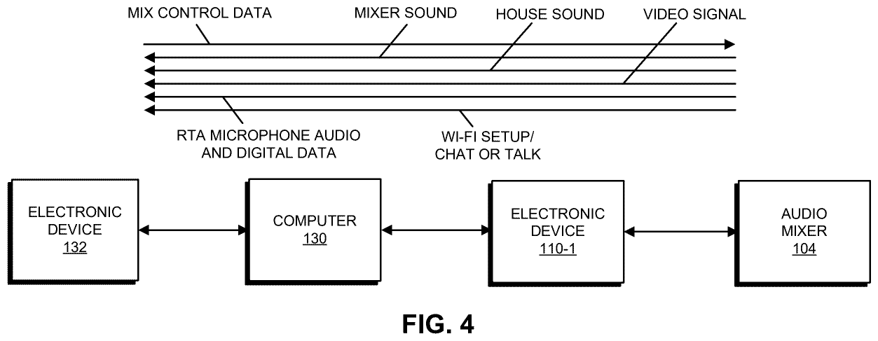

FIG. 4 is a drawing illustrating an example of a RMIX service signal flow in a remote audio-mixing system (which is sometimes referred to as an ‘RMIX service system’). The remote audio-mixing system may enable audio engineers to control and troubleshoot digital mixing consoles remotely, thereby ensuring high-quality, real-time audio management.

The remote audio-mixing system may include a remote workstation (e.g., electronic device 132, which may provide remote support). An audio engineer may access the remote workstation to provide an audio mixing service. The audio engineer may use the workstation to send and receive control data and audio and/or video streams.

In FIG. 4, a first router (or remote router) may be proximate to the remote workstation. The software downloaded and installed on the remote workstation (or computer) may handle the transmission of data packets coming from the RMIX server (or audio mixer) and the RMIX device (such as electronic device 110-1, which is sometimes referred to as a ‘gate’ or a ‘gate device’).

Moreover, in FIG. 4, a communication network (e.g., the Internet) allows remotely located devices to exchange information and data, including control signals (or control data) and audio and/or video streams.

Furthermore, a second router (or on-site router) is proximate to the on-site audio equipment (such as audio mixer 104). In some embodiments, the on-site router may be coupled to the RMIX device and the audio mixer, and may provide these components access to the communication network. Note that the on-site router may be coupled to the audio mixer via Wi-Fi or Ethernet using the RMIX device.

The RMIX device may be located at the on-site venue and may serve as an interface between the remote audio engineer and the on-site audio-mixing console. It may: receive or capture audio signals from the audio mixer, process them, and transmit them over a network (such as the Internet) to the remotely located audio engineer. The audio engineer can then send control commands back to the audio mixer via the RMIX device. Additionally, the RMIX device may receive or capture ambient sounds using its associated microphones and may provide real-time audio feedback to the audio engineer. In some embodiments, the RMIX device may receive and the send one or more of: stereo headphone output audio from the audio mixer; real-time analyzer (RTA) audio and data from one or more connected RTA microphone(s); live video camera footage of the venue stage from one or more connected images sensors or cameras; and/or intercom signals from the one or more microphones to enable communication with the remote audio engineer.

Additionally, in FIG. 4, a digital mixer (or audio-mixing console, which is sometimes referred to as an ‘audio mixer’) may be located on-site at the venue and may be remotely controlled, e.g., using the RMIX device. The digital mixer may process the audio signals from various sources and may output individual and mixed audio.

Moreover, in FIG. 4, a gate server (or the RMIX server) may manage various aspects of the remote mixing system, including a UDP/TCP relay (e.g., using Session Traversal Utilities for Network Address Translation or STUN for peer-to-peer (P2P) connections and/or Traversal Using Relays around Network Address Translation or TURN for indirect connections) to ensure reliable data transmission; a console (such as a Web console) to provide a user interface for remote control and monitoring; a payment module to manage subscription and payment processing for the service; and a login module to manage the user login process.

Furthermore, in FIG. 4, a user electronic device (e.g., a smartphone or tablet) to set up the Wi-Fi connection of the RMIX device and to communicate with the remotely located audio engineer.

We now describe exemplary data flows for the remote audio-mixing system. Mix control data (TCP/UDP): control commands for the audio mixer may be sent from the remote workstation to the audio mixer via the RMIX device. These commands may include: channel configuration, adjustments to volume, effects, equalization (EQ), Compressor, routing, and/or other audio-mixing parameters.

Mixer sound (headphone, after fader listen (AFL), pre-fader listen (PFL), bus, main, etc.): the audio engineer may monitor different outputs from the audio mixer, such as the headphone mix, the AFL, the PFL, bus mixes, and the main mix. This audio may be streamed back to the remote workstation.

House sound (internal and external stereo microphone): in some embodiments, the RMIX device may include a microphone to receive sound waves (e.g., the ambient sound from the venue) and to convert them into electrical signals that are transmitted to the remote workstation. This may allow the audio engineer to hear what the audience is hearing at the venue although the engineer is at a remote location. One or more additional external condenser microphones may be connected to the RMIX device to improve the accuracy and quality of the ambient sound from the venue.

RTA microphone audio and data: the audio engineer may monitor and check the house sound measurements at the venue using the RMIX device. An RTA microphone may be connected to the RMIX device, and the RTA software may be built into the RMIX device according to the demands or needs of the customer.

Chat/talk: a communication channel may be established between the remotely located audio engineer and on-site personnel, thereby enabling real-time discussion and troubleshooting. Note that the remotely located audio engineer may communicate with the staff at the venue through an intercom system (e.g., Clear-Com of Carlsbad, California) via the RMIX device.

Thus, the remote audio-mixing system may provide the flexibility and efficiency of audio engineers by allowing them to provide high-quality mixing and troubleshooting services from a remote location. This may eliminate the need for the audio engineers to be physically present at the venue, thereby reducing costs and increasing accessibility to professional audio services.

The RMIX device may facilitate seamless communication and control between the remotely located audio engineer and the on-site digital mixing console. The RMIX device may include: two XLR female connectors that connect to the channel out of the audio mixer and that receive audio output from the channels of the audio mixer; two XLR female connectors that connects to one or more RTA microphones to measure the acoustic status of a venue from a remote location; a TRS (Tip, Ring, Sleeve) connector that connects to a headphone out/auxiliary of an audio mixer to receive audio signals from the audio mixer; a headphone jack that can be used to monitor audio directly from the RMIX device; two High-Definition Multimedia Interface (HDMI) connectors to receive video signals received from a video mixer; two Universal Serial Bus (USB) connectors for use with one or more USB cameras; a power indicator to show the power status of the RMIX device; audio in/out indicators to show the status of audio input and output; a 48V light emitting diode (LED) to show whether 48V phantom power is being supplied to the connected microphones; and/or one or more internal stereo microphones (or built-in microphones) that may be used to capture ambient sound.

As indicated previously, note that the RMIX device may include multiple microphones, e.g., microphone right and microphone left, that may be used to capture ambient sounds from the environment. An analog-to-digital converter or ADC and a digital-to-analog converter DAC (e.g., 48k or 96k ADC) may handle the conversion of analog audio signals to digital and vice versa, supporting sampling rates of 48 kHz and 96 kHz. In other embodiments, other sampling rates may be used. A Bluetooth module and/or a Wi-Fi module may be used to connect to other electronic devices (e.g., a user device). Moreover, a power indicator may display the current power status, such as from a 48 V power supply that provides power to the one or more connected microphones. An audio input/output port may handle the audio signals coming into and going out of the RMIX device. Furthermore, a reset button may reset the RMIX device to its default state.

The RMIX device may also include an XLR female (XLR-F) connector to interface with the audio mixer to send or receive audio signals to and from the channels of the audio mixer. Moreover, a TRS-F connector may connect the RMIX device to the headphone output or auxiliary output of the audio mixer. A communication port (e.g., an Ethernet port, an intercom port, an HDMI port and/or a USB port) may be used to connect the RMIX device to a local network, thereby enabling remote control and monitoring capabilities.

In some embodiments, the RMIX device may automatically connect to a cloud-based server and send its IP, unique identifier, etc., to the cloud-based server. Note that the audio-mixing system and the RMIX device may use TCP or UDP to connect with the remotely located workstation. The RMIX device may establish a connection between the Internet router via Wi-Fi or Ethernet.

The RMIX device may include: a first communication interface suitable for coupling to a router associated with a venue where real-time audio mixing is needed; a second communication interface suitable for coupling to an audio mixer associated with the venue; and/or a microphone to capture ambient sound from the venue, where the ambient sound from the venue may be converted to audio signals and provided to an audio engineer situated in a remote location. In some embodiments, the RMIX device may bridge the gap between the local audio-mixing console and the remotely located audio engineer by allowing the audio engineer to control the audio mixer (e.g., in real-time) from any location that has Internet access.

Note that the RMIX device may ensure that the digital mixing console can interface with the Internet and the control system of the remotely located engineer, including handling various network protocols and configurations. Moreover, the RMIX device may facilitate ultra-low latency communication (such as a latency of less than 1 s), which may facilitate real-time audio mixing and troubleshooting, thereby ensuring that control commands and audio feedback are transmitted almost instantaneously.

Furthermore, the RMIX device may manage stable data transmission, thereby reducing the chances of interruptions or delays that could impact the quality of audio mixing.

Additionally, the RMIX device may handle multiple audio signals, including input from the: channels, headphone outputs, and auxiliary outputs of the audio mixer. The RMIX device may also send processed audio back to the audio mixer and stream audio to the remotely located engineer.

In some embodiments, by converting analog audio signals to a digital format (and vice versa), the RMIX device may ensure high-quality audio transmission over the Internet. Note that the RMIX device may include one or more internal stereo microphones that capture ambient sound from the venue, thereby enabling the remotely located audio engineer to hear the perspective of the audience at the venue and to make more informed adjustments.

The RMIX device may handle up to four audio channels: two channels for stereo sound coming into the audio mixer and two channels for monitoring the sound as heard by the audience in the venue. A switch or toggle may allow switching between these two sets of channels.

Moreover, the RMIX device may include a first communication interface suitable for coupling to a router associated with a venue where real-time audio mixing is needed; digital mixer status data and control data processing and delivery to the remotely located audio engineer situated in a remote location; a second communication interface suitable for coupling to an audio mixer associated with the venue; and internal and/or external microphone signal processing and handling to capture ambient sound from the venue, where the ambient sound from the venue may be converted into audio signals and provided to a remotely located audio engineer situated in a remote location; capturing, processing, handling and delivering of video signals to the remote audio engineer situated at a remote location; an intercom signal capturing, processing, handling and delivering to the remotely located audio engineer situated in a remote location; and/or an RTA signal capturing, processing, handling and delivering to the remote audio engineer situated in a remote location.

Furthermore, the workstation of the remotely located audio engineer may include software code or program instructions that translate the digital mixer signal to the remote mixing software; and capture and that convert a Music Instrument Digital Interface (MIDI) signal from control surface devices to mixing software.

Note that one or more of the aforementioned components may include fewer or additional features. For example, there may be one or more additional features, one or more fewer features, two or more features may be combined into a single feature, and/or a feature may be divided into two or more features. Note that processes and operations in the components may be performed in series, in parallel and/or may be performed at different times.

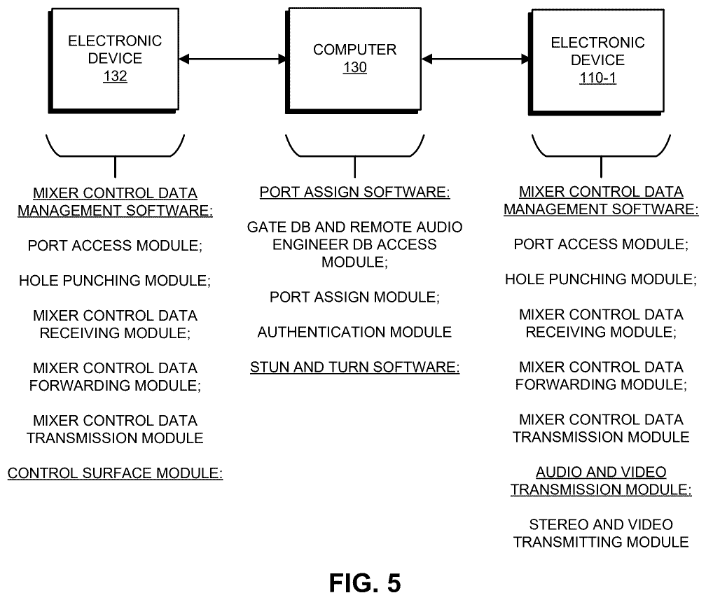

We now describe the functions of and interactions or communication among components in the audio-mixing system. FIG. 5 presents a drawing illustrating an example of functionality of components in a RMIX service system. The RMIX service system may enable virtual mixing capabilities. In the present discussion, the focus is on audio-mixer control data, as opposed to audio and/or video elements (which may be handled using Web Real-Time Communication or WebRTC).

In existing approaches, a digital mixer may be controlled over a network using software provided by a manufacturer. In these existing approaches, a control device may be connected to an audio mixer via a LAN, or using a network switch. Once the audio mixer and the control device are on the same network, the audio mixer either has its own fixed IP address or gets one through Dynamic Host Control Protocol (DHCP). The control software may then find the audio mixer using a specific message protocol from the manufacturer.

The ways these systems communicate messages varies with the manufacturer (or a manufacturer-specific message protocol may be used). Some use TCP/IP, others use UDP/IP, and some use both protocols. These network packets may contain messages that are used by the control software and audio mixer. Note that the communication may flow in both directions. Thus, when something changes on the audio mixer, it may update what you see in the control software, and vice versa. For example, an X32 Digital Mixer (from Behringer of Willich, Germany) may connect to its dedicated control software (X32 EDIT) using UDP/IP. In the discussion that follows, a Behringer audio mixer is used as an illustration of the communication techniques.

While manufacturers typically use different protocols, legacy systems typically communicate between control software and audio mixers using manufacturer-specific message protocols over a network connection. However, consequently, the controlling device (with the downloaded control software) usually cannot control the audio mixer outside of the same network.

The RMIX service system may overcome the network limitations of the existing systems by enabling mixer control over a network, such as the Internet. This may allow audio engineers to control audio mixers from anywhere in the world.

At a high level, the RMIX service system may include a RMIX device coupled to an X32 Digital Mixer (e.g., via a LAN). The RMIX device may be coupled to a cloud-based server via an optional router/firewall of a venue and the Internet, and the cloud-based server may be coupled to an electronic device (such as a computer or workstation) of a remotely located audio engineer via another optional router/firewall and the Internet. There may be three software components in the RMIX service system: a control program in the electronic device of the remotely located audio engineer; a server program in the cloud-based server; and software in the RMIX device.

For the control data, the software in the RMIX device and the electronic device of the remotely located audio engineer may include a mixer control data component, and the software of the server may include a mixer control data relay component. More generally, the electronic device of the remotely located audio engineer may run or execute an X32 EDIT-TOUCH hook program to bind specific ports to connect with the X32-EDIT program and an XTOUCH controller. When desired, the audio engineer may connect XTOUCH to their electronic device via a LAN for physical control. Moreover, when the program receives messages from XTOUCH or X32 EDIT, it may forward them to the RMIX device and vice versa. Moreover, the RMIX device may run or execute a mixer hook program. The audio mixer may use IP address 192.168.20.2 for the program to receive data. With this setup, the audio mixer can send messages to the program, which then delivers them to the electronic device of the remotely located audio engineer and vice versa. Furthermore, the server may, e.g., run or execute two programs to handle connections. The port assign server may check reservations between the electronic device of a remotely located audio engineer and the RMIX device, and may create a dedicated STUN/TURN server for active sessions. Thus, the port assign server may manage separate connections for multiple remotely located audio engineers. For each connection to a remotely located audio engineer, an associated instance of the STUN/TURN server may open the ports specified by the port assign server. When a reservation ends, the instance of the STUN/TURN server may shut down as the session terminates.

Note that the RMIX service system may include: a server structure and multiple session management; different program phases for each session; control software and an audio-mixer connection process; and a structure of the data packets communicated among components of the RMIX service system.

In order to handle multiple sessions simultaneously, the port assign (PA) server may continuously check for reservations and their dedicated port numbers in a data structure or database (which may be hosted on a second cloud-based server). Each session may use two dedicated ports: one for TCP connection, and one for UDP connection. When a client program requests port numbers from the PA server, they may receive either the assigned port numbers for an ongoing reservation or ‘0’ if no reservation exists. For new reservations without assigned ports, the PA server may check for available local ports and may open new ones for that specific session. The port range may be set between 10,000 and 20,000, with each new port increasing by 10 (10,000, 10,010, 10,020, etc.). When opening these ports, the TCP port may get the base number (10,000, 10,010, 10,020, etc.), while the UDP port may add ‘1’ to the TCP port value. For example, a TCP and UDP port pair could be (10,000, 10,001). After creating these ports, the PA server may spawn an instance of a STUN/TURN server with the newly created port information and reservation details. This may ensure the STUN/TURN server knows which ports to open and when to shut itself down, thereby preventing the STUN/TURN server from running beyond the reservation period. At any given time, multiple instances of STUN/TURN servers can be operating, each using different ports for different sessions with different remotely located audio engineers.

We now describe the different program phases for each session. When two client programs (audio engineer side and mixer side) want to connect to each other, the RMIX service system may progress through four different phases: Phase 1: TCP connection establish (initial connection setup); Phase 2: encryption key exchange (setting up secure communication); Phase 3: UDP hole punching (creating pathways through firewalls); and Phase 4: secure message exchange (transferring control data).

In Phase 1, the TCP connection establishment may begin with an instance of the STUN/TURN server generating a 2,048-bit Rivest-Shamir-Adleman (RSA) key pair when it initializes. As clients connect to the server, it may send its RSA public key to both the audio-engineer proxy and the RMIX proxy. Using this public key, each client may securely encrypt its identity (UUID) and may transmit this encrypted data to the cloud-based server. The cloud-based server may then use its private key to decrypt these UUIDs, verifying the identity of each client in the process. Once verification succeeds, the cloud-based server may assign specific client identifiers and may establish authenticated, secure TCP connections with both proxies.

This phase may ensure that: the cloud-based server can authenticate the identity of each client; clients can verify they are connecting to the legitimate cloud-based server; the initial communication channel is secure; and both clients have established reliable TCP connections to the cloud-based server.

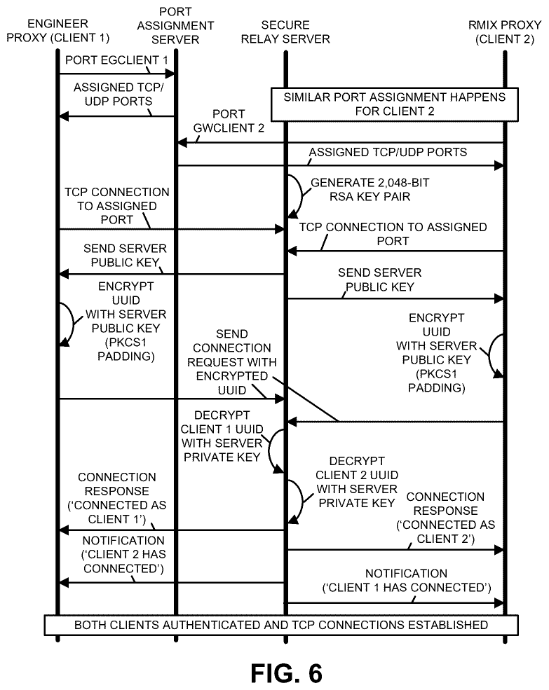

FIG. 6 presents a drawing illustrating an example of communication among components for a RMIX service in Phase 1.

Moreover, in Phase 2, the encryption key exchange may create end-to-end security between the proxies. It may begin with the RMIX proxy generating its own 2,048-bit RSA key pair and sending the public portion to the cloud-based server, which may relay it to the audio-engineer proxy. Upon receiving this key, the audio-engineer proxy may generate a random 256-bit Advanced Encryption Standard (AES) key that will serve as the shared secret for all subsequent communications. This AES key may then be encrypted using the public RSA key of the RMIX proxy, thereby ensuring that only the RMIX proxy can decrypt it. The audio-engineer proxy may send this encrypted AES key through the cloud-based server, which may forward it to the RMIX proxy. Next, the RMIX proxy may use its private RSA key to decrypt the AES key, thereby establishing a shared secret known only to the two proxies.

This phase may provide: a shared secret key known only to the two clients; end-to-end encryption that even the cloud-based server cannot decrypt; forward secrecy (the cloud-based server does not have the ability to decrypt future communications); and a foundation for secure direct communication between the proxies.

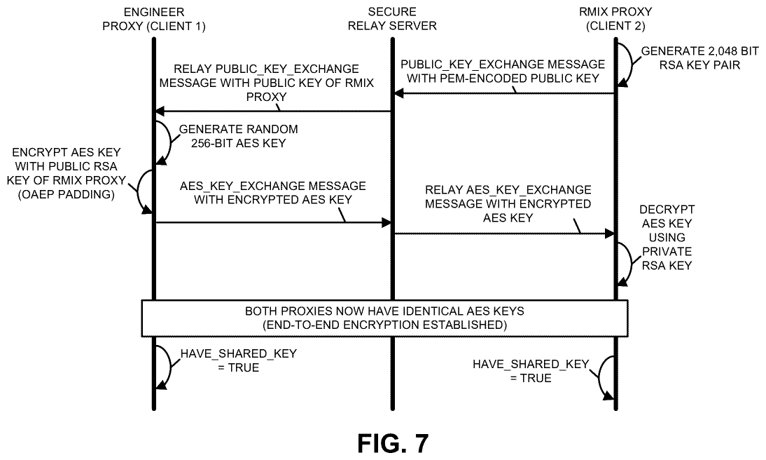

FIG. 7 presents a drawing illustrating an example of communication among components for a RMIX service.

In Phase 3, UDP hole punching may attempt and establish direct peer-to-peer communication between the proxies. The process may start with both clients initializing UDP sockets on their respective systems. The audio-engineer proxy may then send a UDP hole-punch request to the cloud-based server, which records the public IP address and UDP port of each client. The cloud-based server may act as a coordinator, distributing this connection information to both proxies. With the network details for both proxies, both proxies may attempt to send UDP packets directly to each other through their respective Network Address Translation (NAT) firewalls. These simultaneous or approximately simultaneous transmissions may create temporary openings or ‘holes’ in the firewalls that allow direct communication. When either proxy receives a UDP packet from the other, the hole punch may be considered successful, and the RMIX system may switch to direct communication, thereby bypassing the cloud-based server for subsequent messages.

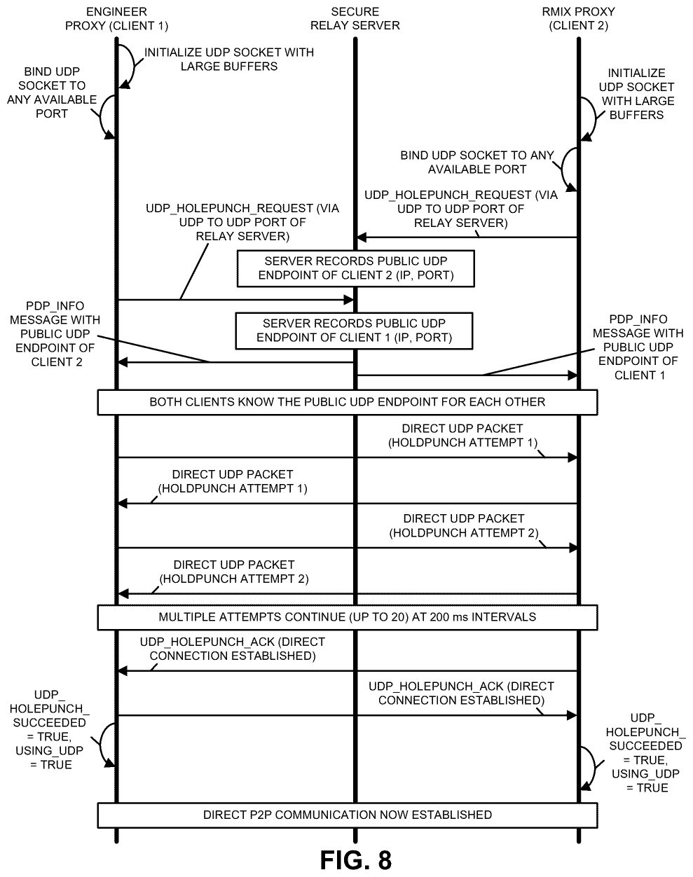

FIG. 8 presents a drawing illustrating an example of communication among components for a RMIX service.

In Phase 4, secure message exchange may be used to handle the actual mixer control-data transmission between software components. When, e.g., the X32-EDIT software sends UDP control messages to the audio-engineer proxy, the audio-engineer proxy may encrypt these messages using the shared AES key established earlier. The audio-engineer proxy may then determine the best path for transmission, either sending the encrypted data directly to the RMIX Proxy via UDP (when hole punching succeeded) or relaying it through the cloud-based server (as a fallback) using TCP. Upon receiving these encrypted messages, the RMIX proxy may decrypt them using the shared AES key and may forward the original control commands to the X32 Digital Mixer. Responses from the X32 Digital Mixer may follow the same path in reverse, maintaining end-to-end security throughout the entire communication process.

Thus, there may be two Communication Paths. In a direct peer-to-peer path, messages may be sent directly between proxies over UDP. This may offer lower latency and no cloud-based server dependency. It may be used when UDP hole punching succeeds. However, it may be subject to packet loss.

Alternatively, a server relay path (TCP fallback) may be used when direct UDP communication fails. Messages may still be encrypted with the shared AES key. The cloud-based server cannot read message contents. Instead, it may relay the encrypted control data. This approach may have higher latency, but may still be secure end-to-end. Note that, in some embodiments, the modification of the data packets may be used with the relay-path communication.

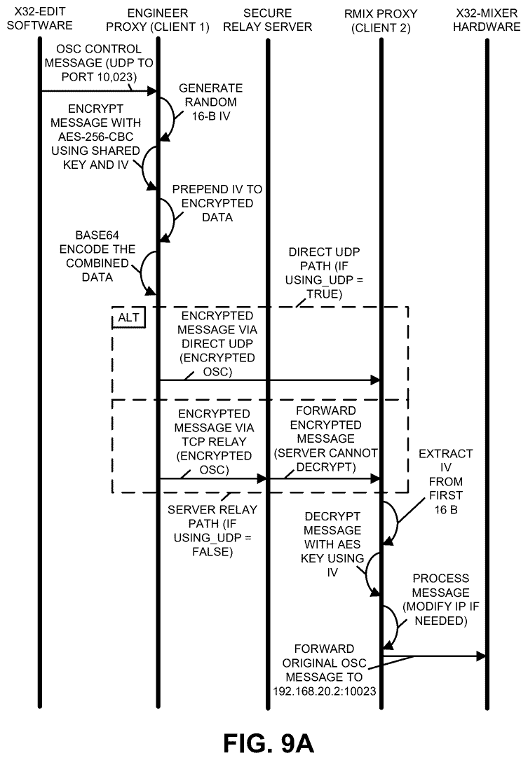

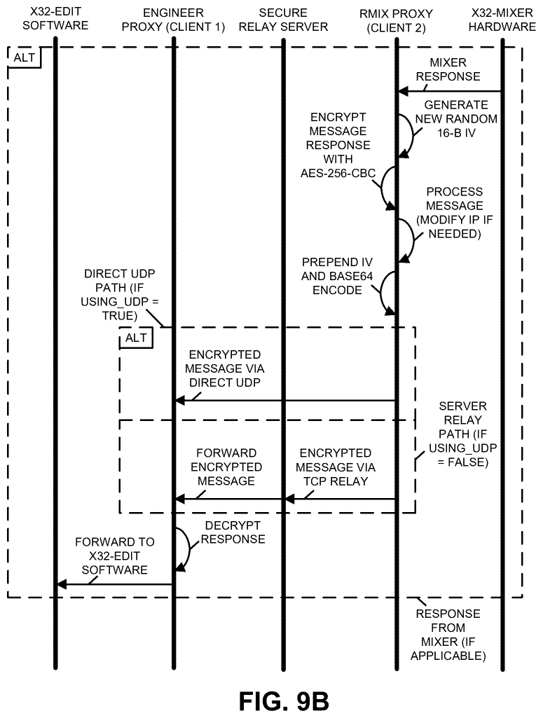

FIGS. 9A and 9B present drawings illustrating an example of communication among components for a RMIX service.

In the control software and audio-mixer connection process, once a secure connection between clients is established, the X32-EDIT software can connect with the X32 digital mixer. While connection techniques vary by manufacturer, each audio mixer and its software may share connection logic that the RMIX device manages. In the discussion that follows, X32 EDIT and X32 are used as illustrative examples.

In a legacy system, when you open the X32-EDIT program on your electronic device (such as a computer), it may send a packet looking for any X32 Digital Mixer on the network. This UDP packet may be sent to port 10,023 and may contain: [1 2f 78 69 6e 66 6f 00 00 2x 00 00 00]. In ASCII, this translates to [/xinfo]. When an audio mixer is on the same network, it may respond with [/xinfo, ssss192.168.200.115X32R-09-7A-5DX32R4.09]. This may tell X32 EDIT that an audio mixer exists, and the program shows this mixer as available for connection.

When a user (such as an audio engineer) then clicks the ‘connect’ button, the program may send [/status,]. The audio mixer may then respond with [/status, sssactive192.168.200.115X32R-09-7A-5D]. At this point, both devices are connected, and the user can control the audio mixer through the software.

Note that the normal connection logic may not work in a remote setup. This is because the audio mixer does not actually exist at the given private IP address (such as 192.168.200.115 in the preceding example). The RMIX system may solve this problem as follows.

In the X32-EDIT software, the audio mixer IP address may be set to 127.0.0.1:10023 (localhost). This may work because the RMIX client program is already bound to 127.0.0.1:10023 and can act as a ‘fake audio mixer.’ Moreover, this may let the X32-EDIT software connect directly to the audio-engineer client program.

Thus, in the RMIX system, the software may be tricked into thinking it is talking to a local audio mixer, when it's actually talking to the RMIX client, which then handles the real remote communication.

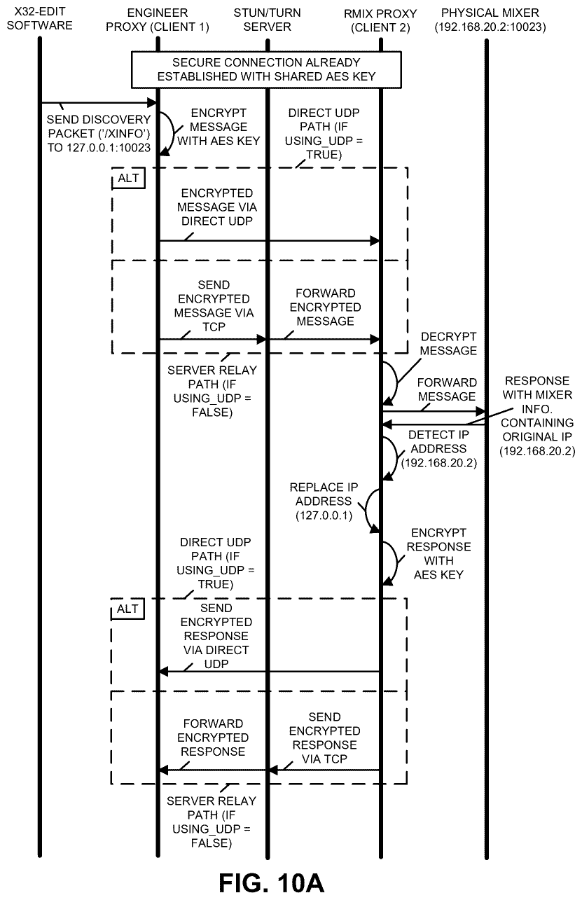

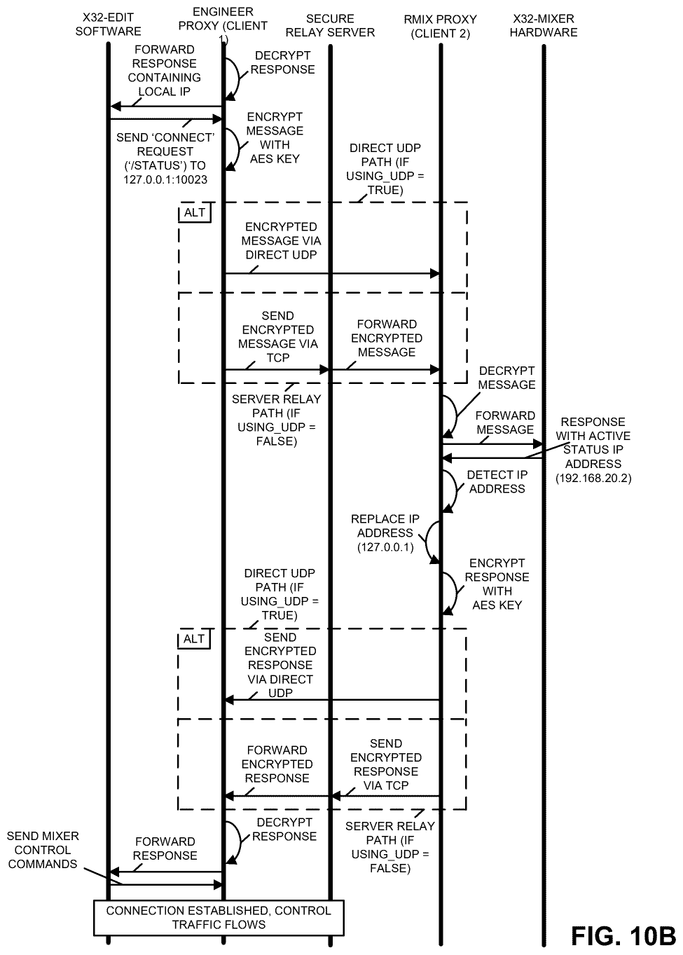

FIGS. 10A and 10B present drawings illustrating an example of communication among components for a RMIX service.

In the RMX service system, client authentication may be implemented using RSA_public_encrypt, while key generation and management may rely on EVP_PKEYfunctions. Message security may be handled through EVP_Encrypt/Decrypt operations. Moreover, the key exchange protocol may work as follows. Client 2 may generate an RSA keypair and share its public key through the cloud-based server. Then, client 1 may generate a random AES-256 key, encrypt it with the public key of client 2, and send it via the cloud-based server. This may establish a shared symmetric key that both clients use for end-to-end encrypted communications. This approach may work for both TCP and UDP connections (after hole punching). While the cloud-based server may facilitate connections, it cannot read the encrypted messages exchanged between clients.

Moreover, hole punching may be used to establish direct connections between clients that are behind NAT firewalls. When electronic devices are on private networks, they typically cannot be directly reached from the public Internet. This creates a challenge for peer-to-peer communication.

The UDP hole punching used in the communication techniques may work by having both clients first connect to the cloud-based server. The cloud-based server may help clients discover each of their public IP addresses and ports. Then, both clients may send packets to each other's public end points simultaneously, effectively ‘punching holes’ through their respective NAT firewalls. Once these holes are established, the clients can communicate directly without routing all their traffic through the cloud-based server.

Note that STUN and TURN may be networking protocols designed to solve connection problems when electronic devices are behind NAT routers. STUN may help the electronic devices discover their public IP address and port by contacting a STUN server on the public Internet, which reports back how the electronic device appears to the outside world, thereby enabling direct peer-to-peer connections in many cases. When STUN is not sufficient because of restrictive NAT configurations or firewalls, TURN may provide a fallback solution by acting as a relay server through which communication passes, thereby ensuring connectivity at the cost of some additional latency and server resources. Note that the communication techniques may use the core functionality of STUN/TURN servers to meet the specific requirements of the disclosed communication techniques, including: managing connections between clients during their designated reservation times; facilitating hole punching by helping clients share their IP address and port information; and/or providing data relay capabilities as a fallback when direct connections fail. This approach may provide an optimized solution that meets the needs of the RMIX system.

We now discuss the data packet or message structure. The RMIX system may employ a binary message protocol designed for efficiency and flexibility. Each message may begin with a fixed-size header containing metadata, followed by variable-length sender identification and payload sections. The header may include the message type (e.g., a single byte identifying the operation), a sender length (e.g., two bytes), a timestamp (e.g., four bytes), and a payload length (e.g., four bytes). This structure may allow messages to be properly framed and processed despite being transmitted over both reliable TCP and unreliable UDP transports. Note that the multi-byte values in the header may be stored in network byte order (big-endian) to ensure cross-platform compatibility. In some embodiments, after the header comes the sender identifier, which may allow messages to be properly routed, followed by the actual message payload (whose size varies based on the message type). The message structure may support everything from connection handshakes to encrypted data transfer.

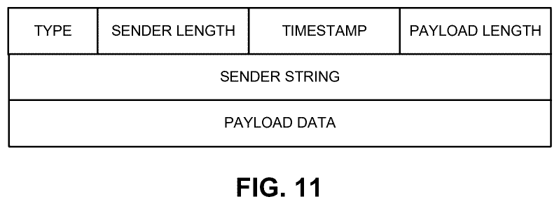

FIG. 11 presents a drawing illustrating an example of a format of a data packet, such as the header of a data packet. The message or data packet header structure may include: a message type (e.g., one byte) to identify the purpose of the message (connection request, encryption key exchange, encrypted data, etc.); a sender length (e.g., two bytes), which may include a size of the sender identifier string in bytes; a timestamp (e.g., four bytes), such as a Unix timestamp for the message creation time; and a payload length (e.g., four bytes), which may indicate a size of the payload in bytes. Note that the sender string and the payload data may, in general, have a variable length. In some embodiments, a first few bytes of the payload may indicate a client identifier.

Note that the protocol may define 17 distinct message types to handle the aspects of the communication process, including: system messages (ERROR, SUCCESS, NOTIFICATION); connection handling (CONNECTION_REQUEST, CONNECTION_RESPONSE); encryption setup (PUBLIC_KEY_EXCHANGE, AES_KEY_EXCHANGE); data transfer (ENCRYPTED_MESSAGE, XTOUCH_MESSAGE); connection management (HEARTBEAT, HEARTBEAT_ACK); and peer-to-peer setup (P2P_INFO, UDP_HOLEPUNCH_REQUEST, UDP_HOLEPUNCH_ACK).

In some embodiments, the RMIX system may enable virtual control of digital audio-mixing devices over network connections. The RMIX system may facilitate remote operation of professional audio equipment through secure communication channels and protocol adaptation mechanisms.

Current digital audio-mixing systems typically operate within local network environments. These systems often employ manufacturer-specific communication protocols between control software and mixing hardware. Connection techniques in these existing systems may include direct device-to-device networking or through intermediate network infrastructure.

Moreover, communication protocols may vary by manufacturer, using standard network transport layers with proprietary message formats. These systems may support bidirectional communication, allowing real-time synchronization between control interfaces and audio-processing hardware.

However, the existing control systems often cannot operate beyond local network boundaries, restricting remote operation capabilities. Additionally, audio and video transmitting are usually not possible within these systems. While port forwarding could potentially enable remote access by opening specific network ports on routers or firewalls, this approach typically introduces significant security risks by exposing internal systems to external networks and potential unauthorized access.

The disclosed RMIX system may overcome geographical limitations and audio/video transmitting challenges by establishing secure communication channels over wide-area networks, enabling remote control of audio-mixing equipment from an arbitrary location with full audio and video transmission capabilities.

The RMIX system may include three primary software modules: a control interface module (which may integrate with existing manufacturer control software, such as an X32-edit/xtouch hook program); a device interface module that communicates with digital mixing hardware or an audio mixer; and/or a communication bridge that facilitates secure data transmission between remote components (such as a port-assign server and/or a STUN/TURN server).

Note that the RMIX system may create a virtual local environment for control software while maintaining secure remote communication with target mixing devices. This approach may preserve existing manufacturer protocols while extending operational range.

Moreover, the RMIX system may support concurrent remote sessions through dynamic resource allocation managed by one or more coordination servers. An instance of the server may continuously monitor session reservations and schedules, and may automatically assign network resources as sessions are initiated or terminated. The coordination technique may establish dedicated communication pathways for each active session, thereby ensuring isolated and secure connections between remote participants.

Each session may operate with its own dedicated network resources and security context, preventing interference between concurrent operations. The instance of the server may dynamically allocate port ranges and may manage the lifecycle of communication channels, automatically cleaning up resources when sessions conclude. This architecture may enable multiple audio engineers to simultaneously control different mixing devices or may allow collaborative control of the same mixing device through properly managed access controls.

Furthermore, remote connection establishment may follow a structured four-phase process designed to ensure secure, reliable communication between geographically separated components.

In phase 1, a secure connection may be established. Notably, the initial phase may establish a secure foundation for subsequent communications. During this phase, the system may perform mutual authentication between remote endpoints. Each participating component may present its credentials using asymmetric encryption techniques, allowing verification of identity without exposing sensitive authentication data. The instance of the server may coordinate this authentication process, generating and distributing cryptographic key pairs to establish trusted communication channels. At this point, the two components (the control interface module and the device interface module, which may be remote endpoints in the communication) may be safely connected to the instance of the server (e.g., via a communication bridge, such as a STUN/TURN server).

Then, in phase 2, cryptographic keys may be exchanged. Notably, phase 2 may establish end-to-end encryption between the remote endpoints, ensuring that subsequent communication remains private even from the instance of the relay server. During this phase, one endpoint may generate an asymmetric key pair and may share its public key through the instance of the relay server to the other endpoint. The receiving endpoint may then create a symmetric encryption key and may securely transmit it back by encrypting it with the shared public key. This encrypted symmetric key may pass through the instance of the relay server, but because only the originating endpoint possesses the corresponding private key, the instance of the server may not decrypt or access the symmetric key. Once the symmetric key is successfully decrypted by the originating endpoint, both endpoints may possess identical encryption keys, enabling them to communicate with full end-to-end encryption. This architecture may ensure that while the instance of the relay server facilitates the key exchange process, it has no access to the actual encryption keys or the content of future communication, thereby providing true peer-to-peer security through the relay infrastructure.

Phase 3 may provide network traversal. Notably, phase 3 may establish a direct communication path between the remote endpoints, eliminating the need for data to traverse through the instance of the relay server and significantly improving performance. During this phase, each endpoint may prepare its direct communication capabilities and may request connection information from the instance of the relay server, which may record the network location details of each endpoint. The instance of the server may then facilitate discovery by sharing the connection information of each endpoint with the other, enabling them to attempt direct peer-to-peer communication. However, because most networks employ firewalls and network address translation that block unsolicited incoming connections, the endpoints may need to perform coordinated connection attempts to traverse these network barriers. Through multiple simultaneous connection attempts from both sides, the endpoints may successfully ‘punch through’ these network obstacles and may establish a direct communication channel. Once this direct path is confirmed by both endpoints, they may be able to communicate efficiently without routing data through the instance of the relay server, thereby achieving peer-to-peer connectivity, while maintaining the security established in previous phases. This approach may optimize bandwidth usage, reduce latency, and minimize the computational load of the instance of the relay server.

Secure data exchange may occur in phase 4. Notably, phase 4 may represent an operational phase in which actual application data may flow securely between remote systems through the established infrastructure. During this phase, application software may send data to the first remote endpoint, which may encrypt the information using the shared encryption keys established in phase 2. The encrypted data may then travel either via the direct peer-to-peer connection established in phase 3 (for optimal performance) or through the instance of the relay server path (as a fallback option). When data passes through the instance of the relay server, the instance of the relay server may not decrypt or inspect the content because of the end-to-end encryption, ensuring complete privacy. Upon reaching the second remote endpoint, the data may be decrypted, processed as needed for the target system, and forwarded to its destination. Response data may follow the same secure path in reverse, creating a bidirectional, encrypted communication tunnel. This phase may be the culmination of the previous phases, in which the RMIX system may now transparently and securely relay application traffic between remote networks, while maintaining both security and performance through end-to-end encryption and/or optimized routing paths.

Note that a protocol application layer in the RMIX system may implement protocol translation techniques to maintain compatibility with existing manufacturer systems, while enabling remote operation capabilities. This adaptation layer may intercept communications between control software and mixing hardware, translating and routing messages through the remote communication infrastructure. The RMIX system may perform message format adaptation to ensure compatibility across different protocol implementations while preserving the semantic meaning and timing requirements of control commands.

Moreover, note that network address translation techniques may redirect communication flows from local network addressing techniques to remote endpoints, creating the illusion that remote mixing devices are present on the local network. The system may synthesize appropriate responses to discovery and connection requests, thereby maintaining the expected behavior patterns that control software relies upon. This approach may ensure that existing manufacturer software can operate without modification while benefiting from extended remote capabilities.

The RMIX system may provide a real-time communication platform for audio and/or video. Notably, audio and video transmission may use WebRTC-based communication frameworks, providing standardized media streaming capabilities with customizable interfaces for professional audio applications.

Moreover, the cryptographic implementation may provide security techniques that employ industry-standard cryptographic libraries, which may include: asymmetric encryption for key exchange; symmetric encryption for data transmission; digital authentication protocols; secure random number generation; and/or custom key-exchange protocols that establish shared secrets between remote endpoints while maintaining server-agnostic security.

Furthermore, the RMIX system may implement network address translation traversal techniques to establish direct communication pathways between network-isolated devices. This may include: public endpoint discovery; coordinated firewall traversal; direct peer-to-peer connection establishment; and/or fallback relay techniques.

Additionally, the RMIX system may use connection management techniques. For example, the network connectivity may use an adapted implementation of traversal protocols, customized for specific application requirements. In some embodiments, the connection management techniques may include: session management during designated time periods; network information coordination; and/or relay capabilities for restricted network environments.

We now describe embodiments of an electronic device, which may perform at least some of the operations in the communication techniques. FIG. 12 presents a block diagram illustrating an example of an electronic device 1200 in accordance with some embodiments, such as one of: audio mixer 104, base station 108, electronic device 110-1, computer system 112, one of access points 116, one of radio nodes 118, switch 128, computer 130, or electronic device 132. This electronic device includes processing subsystem 1210, memory subsystem 1212, and networking subsystem 1214. Processing subsystem 1210 includes one or more devices configured to perform computational operations. For example, processing subsystem 1210 can include one or more microprocessors, graphics processing units (GPUS), ASICs, microcontrollers, programmable-logic devices, and/or one or more digital signal processors (DSPs).

Memory subsystem 1212 includes one or more devices for storing data and/or instructions for processing subsystem 1210 and networking subsystem 1214. For example, memory subsystem 1212 can include DRAM, static random access memory (SRAM), and/or other types of memory. In some embodiments, instructions for processing subsystem 1210 in memory subsystem 1212 include: one or more program modules or sets of instructions (such as program instructions 1222 or operating system 1224, such as Linux, UNIX, Windows Server, or another customized and proprietary operating system), which may be executed by processing subsystem 1210. Note that the one or more computer programs, program modules or instructions may constitute a computer-program mechanism. Moreover, instructions in the various modules in memory subsystem 1212 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 1210.

In addition, memory subsystem 1212 can include mechanisms for controlling access to the memory. In some embodiments, memory subsystem 1212 includes a memory hierarchy that comprises one or more caches coupled to a memory in electronic device 1200. In some of these embodiments, one or more of the caches is located in processing subsystem 1210.

In some embodiments, memory subsystem 1212 is coupled to one or more high-capacity mass-storage devices (not shown). For example, memory subsystem 1212 can be coupled to a magnetic or optical drive, a solid-state drive, or another type of mass-storage device. In these embodiments, memory subsystem 1212 can be used by electronic device 1200 as fast-access storage for often-used data, while the mass-storage device is used to store less frequently used data.

Networking subsystem 1214 includes one or more devices configured to couple to and communicate on a wired and/or wireless network (i.e., to perform network operations), including: control logic 1216, an interface circuit 1218 and one or more antennas 1220 (or antenna elements). (While FIG. 12 includes one or more antennas 1220, in some embodiments electronic device 1200 includes one or more nodes, such as antenna nodes 1208, e.g., a metal pad or a connector, which can be coupled to the one or more antennas 1220, or nodes 1206, which can be coupled to a wired or optical connection or link. Thus, electronic device 1200 may or may not include the one or more antennas 1220. Note that the one or more nodes 1206 and/or antenna nodes 1208 may constitute input(s) to and/or output(s) from electronic device 1200.) For example, networking subsystem 1214 can include a Bluetooth™ networking system, a UDP networking system, a TCP networking system, a cellular networking system (e.g., a 3G/4G/5G network such as UMTS, LTE, etc.), a USB networking system, a coaxial interface, an HDMI interface, a networking system based on the standards described in IEEE 802.11 (e.g., a Wi-Fix networking system), an Ethernet networking system, and/or another networking system.

Note that a transmit or receive antenna pattern (or antenna radiation pattern) of electronic device 1200 may be adapted or changed using pattern shapers (such as directors or reflectors) and/or one or more antennas 1220 (or antenna elements), which can be independently and selectively electrically coupled to ground to steer the transmit antenna pattern in different directions. Thus, if one or more antennas 1220 include N antenna pattern shapers, the one or more antennas may have 2^{N} different antenna pattern configurations. More generally, a given antenna pattern may include amplitudes and/or phases of signals that specify a direction of the main or primary lobe of the given antenna pattern, as well as so-called ‘exclusion regions’ or ‘exclusion zones’ (which are sometimes referred to as ‘notches’ or ‘nulls’). Note that an exclusion zone of the given antenna pattern includes a low-intensity region of the given antenna pattern. While the intensity is not necessarily zero in the exclusion zone, it may be below a threshold, such as 3 dB or lower than the peak gain of the given antenna pattern. Thus, the given antenna pattern may include a local maximum (e.g., a primary beam) that directs gain in the direction of electronic device 1200 that is of interest, and one or more local minima that reduce gain in the direction of other electronic devices that are not of interest. In this way, the given antenna pattern may be selected so that communication that is undesirable (such as with the other electronic devices) is avoided to reduce or eliminate adverse effects, such as interference or crosstalk.

Networking subsystem 1214 includes processors, controllers, radios, antennas, sockets, plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 1200 may use the mechanisms in networking subsystem 1214 for performing simple wireless communication between the electronic devices, e.g., transmitting advertising or beacon frames and/or scanning for advertising frames transmitted by other electronic devices as described previously.

Within electronic device 1200, processing subsystem 1210, memory subsystem 1212, and networking subsystem 1214 are coupled together using bus 1228. Bus 1228 may include an electrical, optical, and/or electro-optical connection that the subsystems can use to communicate commands and data among one another. Although only one bus 1228 is shown for clarity, different embodiments can include a different number or configuration of electrical, optical, and/or electro-optical connections among the subsystems.

In some embodiments, electronic device 1200 includes a display subsystem 1226 for displaying information on a display, which may include a display driver and the display, such as a liquid-crystal display, a multi-touch touchscreen, etc.

Moreover, electronic device 1200 may include a user-interface subsystem 1230, such as: a mouse, a keyboard, a trackpad, a stylus, a voice-recognition interface, and/or another human-machine interface. In some embodiments, user-interface subsystem 1230 may include or may interact with a touch-sensitive display in display subsystem 1226.

Electronic device 1200 can be (or can be included in) any electronic device with at least one network interface. For example, electronic device 1200 can be (or can be included in): a desktop computer, a laptop computer, a subnotebook/netbook, a server, a tablet computer, a cloud-based computing system, a smartphone, a cellular telephone, a smartwatch, a wearable electronic device, a consumer-electronic device, a portable computing device, an access point, a transceiver, a router, a switch, communication equipment, an eNodeB, a controller, test equipment, and/or another electronic device.

Although specific components are used to describe electronic device 1200, in alternative embodiments, different components and/or subsystems may be present in electronic device 1200. For example, electronic device 1200 may include one or more additional processing subsystems, memory subsystems, networking subsystems, and/or display subsystems. Additionally, one or more of the subsystems may not be present in electronic device 1200. Moreover, in some embodiments, electronic device 1200 may include one or more additional subsystems that are not shown in FIG. 12. Also, although separate subsystems are shown in FIG. 12, in some embodiments some or all of a given subsystem or component can be integrated into one or more of the other subsystems or component(s) in electronic device 1200. For example, in some embodiments instructions 1222 is included in operating system 1224 and/or control logic 1216 is included in interface circuit 1218.

Moreover, the circuits and components in electronic device 1200 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 1214 and/or of electronic device 1200. The integrated circuit may include hardware and/or software mechanisms that are used for transmitting wireless signals from electronic device 1200 and receiving signals at electronic device 1200 from other electronic devices. Aside from the mechanisms herein described, radios are generally known in the art and hence are not described in detail. In general, networking subsystem 1214 and/or the integrated circuit can include any number of radios. Note that the radios in multiple-radio embodiments function in a similar way to the described single-radio embodiments.

In some embodiments, networking subsystem 1214 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals).

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used UDP, TCP, Wi-Fi, and/or Ethernet communication protocols as illustrative examples, in other embodiments a wide variety of communication protocols and, more generally, communication techniques may be used. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 1222, operating system 1224 (such as a driver for interface circuit 1218) or in firmware in interface circuit 1218. Alternatively or additionally, at least some of the operations in the communication techniques may be implemented in a physical layer, such as hardware in interface circuit 1218.

Note that the use of the phrases ‘capable of,’ ‘capable to,’ ‘operable to,’ or ‘configured to’ in one or more embodiments, refers to some apparatus, logic, hardware, and/or element designed in such a way to enable use of the apparatus, logic, hardware, and/or element in a specified manner.

While examples of numerical values are provided in the preceding discussion, in other embodiments different numerical values are used. Consequently, the numerical values provided are not intended to be limiting.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
an interface circuit configured to communicate with a second electronic device, wherein the computer system is configured to perform operations comprising:
receiving control data associated with an audio mixer at a first location, wherein the control data has a first data format;
converting the control data from the first data format to a second data format, wherein the control data having the second data format is included in data packets;
adding data tracking elements to the data packets; and
providing, addressed to the second electronic device, the data packets, wherein the second electronic device is at a second location that is different from the first location.

2. The electronic device of claim 1, wherein the first data format comprises User Datagram Protocol (UDP) and the second data format comprises Transmission Control Protocol (TCP).

3. The electronic device of claim 1, wherein the second location is remotely located from the first location.

4. The electronic device of claim 1, wherein, prior to providing the data packets, the operations comprise encrypting the data packets.

5. The electronic device of claim 1, wherein the providing is via a network and a server.

6. The electronic device of claim 5, wherein the network comprises the Internet.

7. The electronic device of claim 1, wherein the data tracking elements facilitate tracking of packet delivery at a server, the second electronic device, or both.

8. The electronic device of claim 1, wherein the data tracking elements facilitate tracking of an order in which the data packets are received at a server, the second electronic device, or both.

9. The electronic device of claim 1, wherein the second electronic device is associated with an audio engineer.

10. The electronic device of claim 1, wherein the audio mixer is different from the electronic device.

11. The electronic device of claim 1, wherein the receiving, the converting, the adding, and the providing are performed for different control data associated with different audio streams, video streams, or both, and, when provided, are addressed to different destinations.

12. A non-transitory computer-readable storage medium for use in conjunction with an electronic device, the computer-readable storage medium storing program instructions, wherein, when executed by the electronic device, the program instructions cause the electronic device to perform one or more operations comprising:
receiving control data associated with an audio mixer at a first location, wherein the control data has a first data format;
converting the control data from the first data format to a second data format, wherein the control data having the second data format is included in data packets;
adding data tracking elements to the data packets; and
providing, addressed to a second electronic device, the data packets, wherein the second electronic device is at a second location that is different from the first location.

13. The non-transitory computer-readable storage medium of claim 12, wherein the first data format comprises User Datagram Protocol (UDP) and the second data format comprises Transmission Control Protocol (TCP).

14. The non-transitory computer-readable storage medium of claim 12, wherein, prior to providing the data packets, the operations comprise encrypting the data packets.

15. The non-transitory computer-readable storage medium of claim 12, wherein the audio mixer is different from the electronic device.

16. A method for providing data packets, comprising:
by an electronic device:
receiving control data associated with an audio mixer at a first location, wherein the control data has a first data format;
converting the control data from the first data format to a second data format, wherein the control data having the second data format is included in the data packets;
adding data tracking elements to the data packets; and
providing, addressed to a second electronic device, the data packets, wherein the second electronic device is at a second location that is different from the first location.

17. The method of claim 16, wherein the first data format comprises User Datagram Protocol (UDP) and the second data format comprises Transmission Control Protocol (TCP).

18. The method of claim 16, wherein, prior to providing the data packets, the operations comprise encrypting the data packets.

19. The method of claim 16, wherein the audio mixer is different from the electronic device.

20. The method of claim 16, wherein the second electronic device is associated with an audio engineer.
